(19) United States
(12) Patent Application Publication
(10) Pub. No.: US 2024/0428324 A1
(43) Pub. Date: Dec. 26, 2024

(54) OFFLINE SIMULATION TO TEST AN EFFECT OF A CONFIGURABLE PARAMETER USED BY A CONTENT DELIVERY SYSTEM

(71) Applicant: Maplebear Inc. (dba Instacart), San Francisco, CA (US)

(72) Inventor: Tianshu Ren, Santa Clara, CA (US)

(21) Appl. No.: 18/213,761

(22) Filed: Jun. 23, 2023

(51) Int. Cl. G06Q 30/08; G06Q 30/0601

(52) U.S. Cl. CPC G06Q 30/08; G06Q 30/0613

(57) ABSTRACT

An online concierge system includes a content selection simulation module that performs offline simulations of a content selection process to enable rapid testing of various content selection parameters. The content selection simulation module obtains historical content selection data including content delivery opportunities and candidate content items associated with those content delivery opportunities. The content selection simulation module simulates the filtering, ranking, and auction stages of a content selection process using a set of configurable content selection parameters that affects selection of a winning content item and price. The winning content items from the simulation may be used to compute performance metrics associated with the configured content selection parameters. Different content selection parameters may be compared to determine an effect of changes to the parameters.

### BACKGROUND

Promotional opportunities in online applications are often controlled by a content selection process of an online system that awards content delivery opportunities to content based on relevance of the content to a specific opportunity or other factors. In a typical process, a set of candidate content items are selected, filtered, ranked, and inputted to a content selection process (or auction) in which a winning content item is selected. In order to test different parameters that control the filtering, ranking, and auction processes, online systems may configure A/B testing in which different parameters are applied to different content delivery opportunities and the resulting performance metrics compared. However, conventional A/B testing is computationally expensive and can take a significant time (e.g., weeks) to gather sufficient results to test even a limited number of selection parameters.

### SUMMARY

In accordance with one or more aspects of the disclosure, a method simulates a content selection process to enable testing of one or more configurable content selection parameters in an online concierge system that facilitates ordering, procurement, and delivery of items to customers from physical retailers. The online concierge system identifies a set of content delivery opportunities for testing the set of configurable content selection parameters for a content selection process. The online concierge system performs a set of offline simulations of the content selection process for the set of content delivery opportunities using the set of configurable content selection parameters to determine a first set of simulated winning content items. The online concierge system derives one or more simulated output metrics for evaluating the set of configurable content selection parameters based on the set of simulated winning content items. The online concierge system selects between at least the set of configurable content selection parameters and a set of baseline content selection parameters based on the one or more simulated output metrics from the set of offline simulations and one or more baseline output metrics for the baseline content selection parameters to obtain selected content selection parameters. The online concierge system configures an online content selection process using the selected content selection parameters. The online concierge system executes the online content selection process to select and output a selected content item for presenting in a user interface of a client device in association with operation of the online concierge system.

In one or more embodiments, a non-transitory computer-readable storage medium stores instructions executable by one or more processors to perform any of the above-described methods. In yet a further embodiment, a computer system includes one or more processors and a non-transitory computer-readable storage medium that stores instructions executable by one or more processors to perform any of the above-described methods.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates an example block diagram of a content selection simulation module.

FIG. 4 is a flowchart illustrating an example process for generating performance metrics characterizing configurable content selection parameters in an offline simulation.

### DETAILED DESCRIPTION

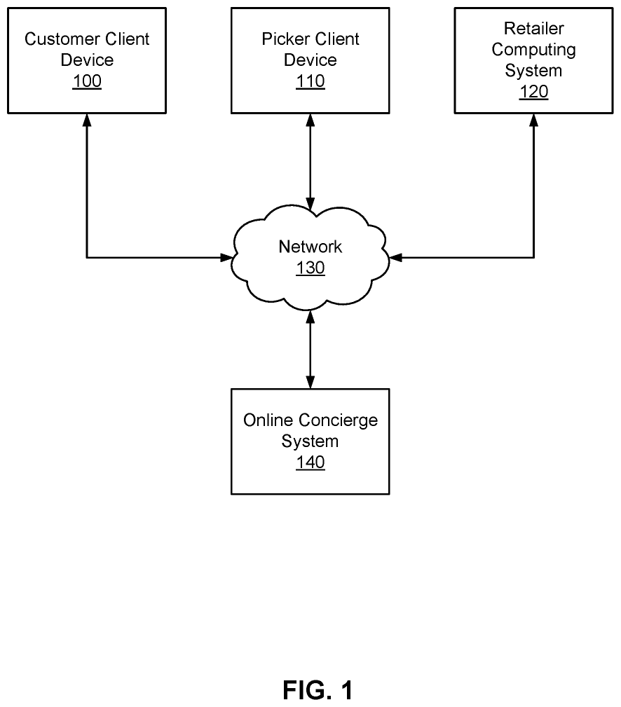

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good or product that can be provided to the customer through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface). The customer client device 100 may furthermore present targeted content to the customer in various contexts, such as, for example, search content items presented in response to a search query, browse content items, or other presentation contexts.

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi or fully autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

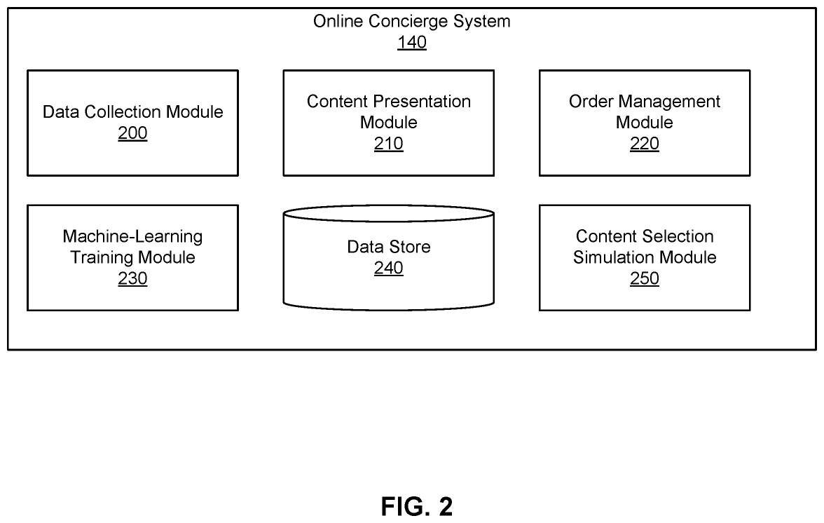

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, a data store 240, and a content selection simulation module 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data and may use databases to organize the stored data.

The content selection simulation module 250 simulates a content selection process to test one or more sets of configurable content selection parameters. By performing simulations, the content selection simulation module 250 enables multiple different combinations of content selection parameters to be tested without necessarily utilizing traditional A/B testing or other testing methods that rely on collecting results from online content selection processes over an extended time period. The content selection simulation module 250 may obtain simulated performance metrics (e.g., impression count, revenue, or other performance metrics associated with content selection) for one or more sets of configurable content selection parameters over various simulations and compare the performance metrics between simulations and/or with actual performance metrics from historical content selection processes. Based on the results of the comparison, the content selection simulation module 250 may configure an online content selection process with the highest performing content selection parameters.

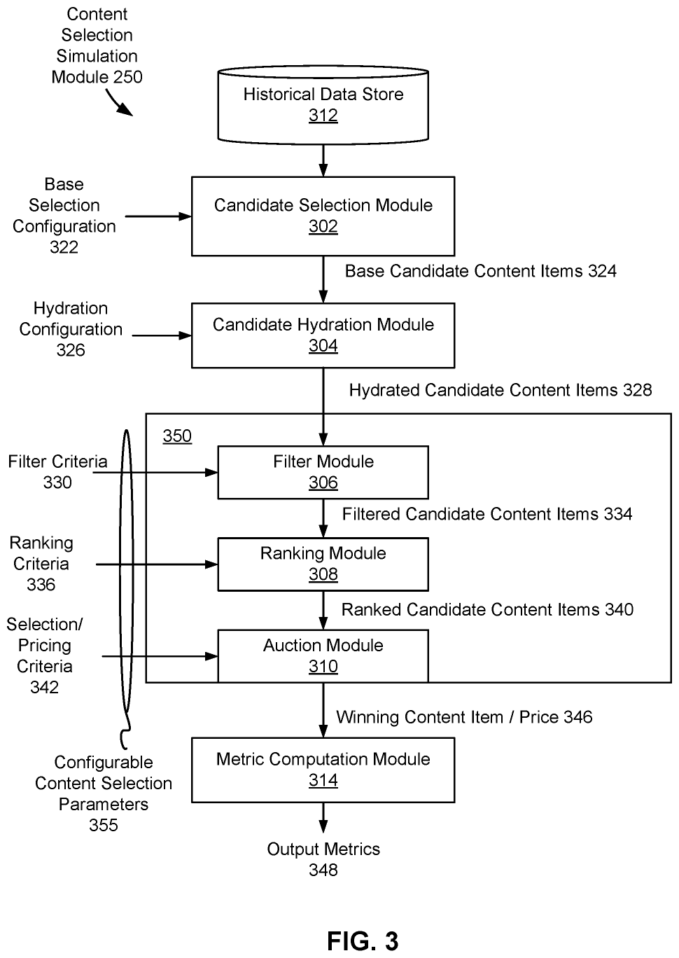

FIG. 3 is a block diagram of one or more embodiments of a content selection simulation module 250. The content selection simulation module includes a historical data store 312, a candidate selection module 302, a candidate hydration module 304, and a core simulation module 350 (including a filter module 306, a ranking module 308, and an auction module 310), and a metric computation module 314. Alternative embodiments may include different or additional modules.

The historical data store 312 stores historical data associated with historical content delivery opportunities, historically selected content items associated with those historical content delivery opportunities, and performance metrics associated with the selected content items. The historical data may furthermore include various filtering, ranking, and auction criteria that were applied to select specific content items from a set of candidate content items for each of the historical content delivery opportunities. The performance metrics associated with the selected content items may include, for example, number of impressions, clicks, click-through-rate (CTR), conversions, conversation rate, revenue, or other metrics for evaluating the effect of viewing content items in an online concierge system 140. The historical data store 312 may include data in the data store 240 described above, or data from other data sources.

The candidate selection module 302 selects a set of base candidate content items 324 for a simulated content delivery opportunity based on base selection configuration 322. In one or more embodiments, the simulated content delivery opportunity may directly represent a historical content delivery opportunity and the set of base candidate content items 324 may represent the historical candidate content items for that content delivery opportunity. In other embodiments, the content delivery opportunity may comprise a configurable content delivery opportunity that does not necessarily reflect a specific historical content delivery opportunity, and the set of base candidate content items 324 may be selected from a pool of historical candidate content items according to various selection criteria specified the base selection configuration 322.

The candidate hydration module 304 applies a hydration configuration 326 to the set of base candidate content items to generate a set of hydrated candidate content items 328 that includes various metadata characterizing the candidate content items that is useful for simulation. The metadata may include information such as, for example, a relevance score of each of the base candidate content items to the simulated content delivery opportunity, a targeting criterion associated with the base candidate content items, or other signals that may affect simulation of the content selection process.

The core simulation module 350 obtains the hydrated candidate content items 328 and applies a set of configurable content selection parameters 355 to simulate a content selection process. The configurable content selection parameters 355 may include at least one parameter set differently than in the historical content selection process, which may therefore result in different simulated winning content items and prices 346 and resulting output metrics 348 associated with the content selection. Configuring different content selection parameters 355 and executing various simulations of the content selection process using the core simulation module 350 enables the simulated output metrics 348 associated with different configurable content selection parameters 355 to be quickly estimated via simulation. The simulated performance of the configurable content selection parameters 355 may then be compared with performance of historical content selection parameters and/or may be compared between multiple simulations to optimize the parameters 355 without necessarily utilizing much slower evaluation processes such as online A/B testing.

In one or more embodiments, the core simulation module 350 includes a filter module 306, a ranking module 308, and an auction module 310. The filter module 306 simulates a content selection filtering process in a manner similar to the filtering process applied in online content selection. The filter module 306 applies filter criteria 330 to the hydrated candidate content items 328 to select a set of filtered candidate content items 334 representing a subset of the hydrated candidate content items 328 meeting the filter criteria 330. The filter criteria may include, for example, a relevance threshold, a targeting criteria threshold, categories, bid thresholds, or other filtering parameters for filtering the hydrated candidate content items 328.

The ranking module 308 simulates a ranking process in a manner similar to the ranking process applied in online content selection. The ranking module 308 applies ranking criteria 336 to the filtered candidate content items 334 to generate a score for ranking the filtered candidate content items 334 into a ranked candidate content items 340. The ranking criteria may include, for example, a scoring function or set of weights associated with a scoring function based on various parameters such as relevance score or other ranking criteria.

The auction module 310 simulates a content auction process in a manner similar to the auction process applied in an online content selection. The auction module 310 applies selection and pricing criteria 338 to the ranked candidate content items 340 to select a winning content item 346 together with a price (to be paid by the winner) for the winning content item. The selection and pricing criteria may be based on the score, bid amounts, or other auction criteria.

The metric computation module 314 computes a set of output metrics 348 based on the winning content items and associated prices 346 from the simulation to characterize the set of configurable content selection parameters 355 (e.g., filtering criteria 330, ranking criteria 336, and/or selection/pricing criteria 342) applied during the simulation. The metric computation module 314 may aggregate metrics associated with the winning content item and price 346 over multiple simulations of different content delivery opportunities while applying the same set of configurable content selection parameters (e.g., filtering criteria 330, ranking criteria 336, and/or selection/pricing criteria 342) such that the output metric represents aggregate performance data that may provide a good estimate of performance for a set of arbitrary content delivery opportunities. The metric computation module 314 may compare output metrics resulting from the simulation to actual baseline metrics derived from historical data for the same set of content delivery opportunities to compare performance of the configurable content selection parameters with the actual baseline parameters utilized in the historical data. Furthermore, the metric computation module 314 may compare simulations associated with multiple different configurable content selection parameters to determine the highest performing set of configurable content selection parameters resulting from a set of simulations using different configurable content selection parameters. Thus, the content selection simulation module 250 may rapidly test a wide range of possible configurations without relying on online A/B testing. The output metrics 348 may comprise statistics such as number of impressions, revenue, or other metrics for characterizing performance of a content selection process.

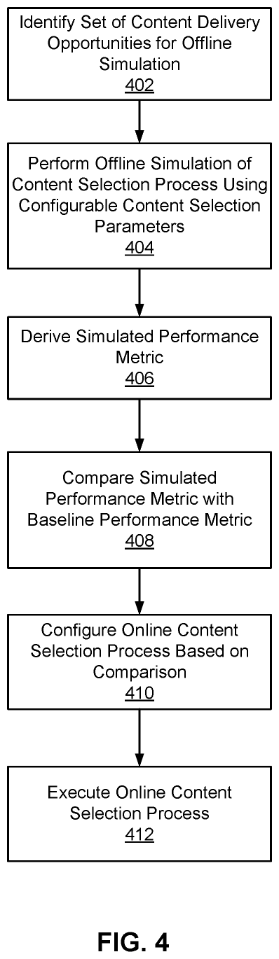

FIG. 4 is a flowchart for a method for simulating a content selection process using configurable content selection parameters, in accordance with some embodiments. Alternative embodiments may include more, fewer, or different steps from those illustrated in FIG. 4, and the steps may be performed in a different order from that illustrated in FIG. 4. These steps may be performed by an online concierge system (e.g., online concierge system 140). Additionally, each of these steps may be performed automatically by the online concierge system without human intervention.

The content selection simulation module 250 identifies 402 a set of content delivery opportunities for testing configurable content selection parameters in an offline simulation of a content selection process. The content selection simulation module 250 performs 404 the offline simulation of the content selection process for the set of content delivery opportunities using configurable content selection parameters to determine a set of simulated winning content items. Here, the offline simulation may involve collecting a set of candidate content items for each of the set of content delivery opportunities and obtaining various metadata characterizing the set of candidate content items (e.g., relevance scores, targeting criteria, etc.). The simulated content selection process may employ a similar process as the historical online selection process but may apply different filtering criteria, ranking criteria, and/or auction criteria in the filtering, ranking, and auction steps respectively. In one or more embodiments, the configurable content selection parameters may be configurable by an administrator via a user interface of an administrative client device.

The content selection simulation module 250 derives 406 a simulated performance metric for evaluating the configurable content selection parameters based on the set of simulated winning content items. The content selection simulation module 250 then compares 408 the simulated performance metric with a baseline performance metric associated with the set of content delivery opportunities based on baseline content selection parameters. The baseline content selection parameters and resulting baseline performance metric may be based on an actual historical content selection process associated with the set of content delivery opportunities and resulting actual performance data or may be based on a different simulation of the content selection process for the set of content delivery opportunities executed using different configurable content selection parameters. The online concierge system 140 may then configure 410 an online content selection process based on the comparison. For example, the online concierge system 140 may configure the parameters in a manner that optimizes performance criteria such as impression count, revenue, etc. The online concierge system 140 executes 412 an online content selection process using the configured parameters to select a selected content item for presenting in a user interface of a client device in association with operation of the online concierge system.

In one or more embodiments, the content items may be sponsored content items, such as ads, where a content owner associated with the sponsored content items provides consideration to the online system in exchange for presenting the content items to one or more users of the online system. In such embodiments, the output metrics may include metrics that evaluate the performance of the ads, such as conversions, click-throughs, impressions, and the like.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include applying the machine learning model to a training example, comparing an output of the machine learning model to the label associated with the training example, and updating weights associated for the machine learning model through a back-propagation process. The weights may be stored on one or more computer-readable media and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
obtaining logged data describing a set of historical content delivery opportunities, wherein a set of baseline content selection parameters were used by a content selection process to select content for the set of historical content delivery opportunities;
performing a set of offline simulations of the content selection process for the set of historical content delivery opportunities, using a set of test content selection parameters to determine a first set of simulated winning content items, wherein the set of test content selection parameters is different than the set of baseline content selection parameters;
deriving one or more simulated output metrics for evaluating the set of test content selection parameters based on the first set of simulated winning content items;
selecting between at least the set of test content selection parameters and the set of baseline content selection parameters, wherein the selecting is based on the one or more simulated output metrics from the set of offline simulations to obtain a set of selected content selection parameters;
configuring an online content selection process using the selected content selection parameters; and
executing the online content selection process to select and output a selected content item for presentation in a user interface of a client device in association with operation of an online system.

2. The method of claim 1, wherein performing the set of offline simulations comprises, for each of the set of offline simulations:
collecting, for a content delivery opportunity of the set of content delivery opportunities, a set of candidate content items;
obtaining metadata characterizing each of the set of candidate content items; and
performing an offline simulation of the content selection process using the set of candidate content items and the metadata.

3. The method of claim 1, wherein using the set of test content selection parameters comprises using at least one filtering parameter, wherein performing the set of offline simulations comprises:
applying one or more filters to filter a set of candidate content items using the filtering parameter to identify a filtered set of candidate content items for ranking and inputting to a simulated content auction.

4. The method of claim 1, wherein using the set of test content selection parameters comprises using ranking criteria, wherein performing the set of offline simulations comprises:
applying the ranking criteria in a ranking process to rank a set of filtered candidate content items into a ranked list for inputting to a simulated content auction.

5. The method of claim 1, wherein using the set of test content selection parameters comprises using at least one auction parameter, wherein performing the set of offline simulations comprises:
performing a simulated content auction to select a simulated winning content item and determining a price for the simulated winning content item.

6. The method of claim 1, further comprising:
obtaining the set of test content selection parameters via a user interface of an administrative client device.

7. The method of claim 1, wherein performing the set of offline simulations comprises:
obtaining a set of historical data relating to historical content delivery opportunities, the historical data identifying the historical content delivery opportunities, historically selected content items for the historical content delivery opportunities, and performance metrics resulting from the historically selected content items.

8. The method of claim 1, wherein deriving the one or more simulated output metrics comprises deriving at least one of: a number of content impressions or revenue.

9. The method of claim 1, further comprising:
obtaining, from historical data relating to historical content delivery opportunities, the baseline content selection parameters and the one or more baseline output metrics.

10. The method of claim 1, further comprising:
obtaining, from another set of offline simulations of the content selection process using different test content selection parameters, the baseline content selection parameters and the one or more baseline output metrics.

11. A non-transitory computer-readable storage medium storing instructions that when executed cause one or more processors to performs steps including:
obtaining logged data describing a set of historical content delivery opportunities, wherein a set of baseline content selection parameters were used by a content selection process to select content for the set of historical content delivery opportunities;
performing a set of offline simulations of the content selection process for the set of historical content delivery opportunities, using a set of test content selection parameters to determine a first set of simulated winning content items, wherein the set of test content selection parameters is different than the set of baseline content selection parameters;
deriving one or more simulated output metrics for evaluating the set of test content selection parameters based on the first set of simulated winning content items;
selecting between at least the set of test content selection parameters and the set of baseline content selection parameters, wherein the selecting is based on the one or more simulated output metrics from the set of offline simulations to obtain a set of selected content selection parameters;
configuring an online content selection process using the selected content selection parameters; and
executing the online content selection process to select and output a selected content item for presentation in a user interface of a client device in association with operation of an online system.

12. The non-transitory computer-readable storage medium of claim 11, wherein performing the set of offline simulations comprises, for each of the set of offline simulations:
collecting, for a content delivery opportunity of the set of content delivery opportunities, a set of candidate content items;
obtaining metadata characterizing each of the set of candidate content items; and
performing an offline simulation of the content selection process using the set of candidate content items and the metadata.

13. The non-transitory computer-readable storage medium of claim 11, wherein using the set of test content selection parameters comprises using at least one filtering parameter, wherein performing the set of offline simulations comprises:
applying one or more filters to filter a set of candidate content items using the filtering parameter to identify a filtered set of candidate content items for ranking and inputting to a simulated content auction.

14. The non-transitory computer-readable storage medium of claim 11, wherein using the set of test content selection parameters comprises using ranking criteria, wherein performing the set of offline simulations comprises:
applying the ranking criteria in a ranking process to rank a set of filtered candidate content items into a ranked list for inputting to a simulated content auction.

15. The non-transitory computer-readable storage medium of claim 11, wherein using the set of test content selection parameters comprises using at least one auction parameter, wherein performing the set of offline simulations comprises:
performing a simulated content auction to select a simulated winning content item and determining a price for the simulated winning content item.

16. The non-transitory computer-readable storage medium of claim 11, wherein the instructions when executed further cause the one or more processors to perform a step of:
obtaining the set of test content selection parameters via a user interface of an administrative client device.

17. The non-transitory computer-readable storage medium of claim 11, wherein performing the set of offline simulations comprises:
obtaining a set of historical data relating to historical content delivery opportunities, the historical data identifying the historical content delivery opportunities, historically selected content items for the historical content delivery opportunities, and performance metrics resulting from the historically selected content items.

18. The non-transitory computer-readable storage medium of claim 11, wherein deriving the one or more simulated output metrics comprises deriving at least one of: a number of content impressions or revenue.

19. The non-transitory computer-readable storage medium of claim 11, wherein the instructions when executed further cause the one or more processors to perform a step of:
obtaining, from historical data relating to historical content delivery opportunities, the baseline content selection parameters and the one or more baseline output metrics.

20. A computer system comprising:
one or more processors; and
a non-transitory computer-readable storage medium storing instructions that when executed cause one or more processors to performs steps including:
obtaining logged data describing a set of historical content delivery opportunities, wherein a set of baseline content selection parameters were used by a content selection process to select content for the set of historical content delivery opportunities;
performing a set of offline simulations of the content selection process for the set of historical content delivery opportunities, using a set of test content selection parameters to determine a first set of simulated winning content items, wherein the set of test content selection parameters is different than the set of baseline content selection parameters;
deriving one or more simulated output metrics for evaluating the set of test content selection parameters based on the first set of simulated winning content items;
selecting between at least the set of test content selection parameters and the set of baseline content selection parameters, wherein the selecting is based on the one or more simulated output metrics from the set of offline simulations to obtain a set of selected content selection parameters;
configuring an online content selection process using the selected content selection parameters; and
executing the online content selection process to select and output a selected content item for presentation in a user interface of a client device in association with operation of an online system.
